(19) United States
(12) Patent Application Publication
(10) Pub. No.: US 2003/0024951 A1
(43) Pub. Date: Feb. 6, 2003

(54) Pump dispenser and spraying apparatus provided with the same

(76) Inventor: Tetsuya Tada, Tokyo (JP)

Correspondence Address: FLYNN, THIEL, BOUTELL & TANIS, P.C., 2026 Rambling Road, Kalamazoo, MI, 46008-1699, US

(21) Appl. No.: 10/008,685

(22) Filed: Dec. 7, 2001

(30) Foreign Application Priority Data
Jul. 31, 2001 (JP) 2001-232248

(51) Int. Cl. B67D 5/40

(52) U.S. Cl. 222/383.1

(57) ABSTRACT

The objective of this invention is to provide a pump dispenser transmitting precisely the trigger motion and enabling stable operation of a piston section. As a means to achieve this objective, a manual operative pump dispenser A mounted on a vessel wherein the liquid contained in the cylinder section is compressed with a piston section by the displacement of a trigger structure and is ejected through the nozzle orifice, including a base body fixed on the vessel orifice via a packing structure, a cylinder section and a vent cylinder section formed in adjacent to each other on the base body, and a trigger structure including a trigger section, a second valve casing section mounted on the base body, and a trigger guide section oscillating in the vent cylinder section is provided.

### BACKGROUND OF THE INVENTION

1. Field of the Invention

This invention relates to a pump dispenser, and in particular to a manual operative pump dispenser wherein the liquid contained in a cylinder is compressed by the displacement of a trigger structure so that the liquid may be ejected from the nozzle orifice and a spraying apparatus provided with the same.

2. Description of Related Art

Traditionally manual operative pump dispensers mounted on a vessel have been used for ejecting liquid.

FIGS. 17 and 18 show examples of the parallel displacement model of this type of pump dispenser, and are respectively a schematic illustration showing how it is used and an expanded sectional view showing specifically its construction.

This pump dispenser 100 is mounted on a liquid vessel B, and the liquid sucked from the vessel B and contained in the cylinder 101 is compressed with a piston 103 by the displacement of the trigger 102 and is ejected from the nozzle 104.

The trigger 102 in this case is on the prolongation of the piston 103 and displaces in parallel, in other words it has a parallel displacement-type construction.

Unlike rotary trigger spraying apparatus, it has no winged protruding trigger and is relatively compact.

In actual use, as shown in FIG. 17 the user operates it by opening the fingers, for example, the index finger and the middle finger and holding the trigger 102 with them.

And by applying force on the fingers holding the trigger and pulling the trigger towards the cylinder 101, the liquid contained in the cylinder 101 is compressed and is ejected from the nozzle 104.

However, the operation of opening the fingers as mentioned above in the traditional examples, holding the trigger 102 with them and pulling the trigger 102 towards the cylinder 101 is different from the usual way of using fingers. Therefore, the operation is complicated and not so easy to perform.

And for example while the index finger and the middle finger are opened and hold the trigger 102, on the other side the inner lower surface of the thumb will be in contact with the back side of the pump dispenser, and when the trigger is pulled with force, the fingers will be in an unnatural state.

Moreover, as shown in FIG. 17 or FIG. 18, the nozzle 104 is arranged at the end of a straight line from the cylinder 101, and therefore in case of a leakage of liquid, due to the position of the nozzle 104 between the fingers, the fingers tends to be soiled with the liquid.

And when the liquid is ejected downward, the whole liquid vessel integrated with the pump dispenser 100 must be inclined for use so that the nozzle 104 may face downward. Thus, a momentum results from the weight of the liquid vessel and burdens the operating hands.

And when the pump dispenser is used in such an inclined position, if the cap 105 is not closed tightly enough, the liquid may leak from the gap between the cap 105 and the orifice of the vessel B.

On the other hand, in case of a pump dispenser with a rotary trigger not shown, as a trigger based on rotary motion is operated to start a linear motion of the piston, the piston and the trigger are connected by a free motion hole.

Accordingly, the transmission of power from the trigger to the piston is not necessary precisely assured, and the oscillating motion of the piston in relation to the cylinder often becomes unstable.

And the trigger, the valve case, etc. are independent, resulting in a large number of components as a whole.

### SUMMARY OF THE INVENTION

This invention was made under such a technical background.

It is therefore an object of this invention to provide a pump dispenser that gives a precise trigger motion to the piston and enables stable motion of the piston.

It is another object of this invention to provide a manual operative pump dispenser that can prevent careless operation of the trigger.

Another object of this invention is to provide a spraying apparatus provided with such a pump dispenser.

Thus, as the result of their devoted and intensive researches carried under such a background, the inventors of this invention found that the various problems mentioned above can be solved by integrating the valve casing (the second valve casing), the trigger section and the trigger guide section into a single trigger structure, and completed this invention based upon this finding.

This invention relates to (1) a manual operative pump dispenser mounted on a vessel wherein liquid contained in the cylinder section is compressed with a piston section by the displacement of a trigger structure and is ejected through the nozzle orifice, and includes a base body fixed on a vessel orifice via a packing structure including a cylinder section and a vent cylinder section formed in adjacent to each other on the base body, the trigger structure including a trigger section, a second valve casing section mounted on the base body, and a trigger guide section oscillating in the vent cylinder section.

This invention also relates to (2) a pump dispenser wherein the nozzle cover is integrated with the second valve casing section via a hinge section.

This invention also relates to (3) a pump dispenser wherein the nozzle cover includes a protrusion designed to block the nozzle orifice.

This invention also relates to (4) a pump dispenser wherein the nozzle cover includes a mesh section for foaming and a nozzle stopper is provided between the nozzle cover and the nozzle orifice for closing the nozzle orifice.

This invention also relates to (5) a pump dispenser wherein the second valve casing section includes an anti-falling section relative to the base body.

This invention also relates to (6) a pump dispenser wherein the second valve casing includes an inside boss section and an outside boss section between which the cylinder section oscillates.

This invention also relates to (7) a pump dispenser wherein a downward slanting extension of the outside boss section of the second valve casing forming a nozzle cover is integrate thereto.

This invention also relates to (8) a pump dispenser wherein a virgin seal for preventing the pull back of the trigger structure is integrated with the vent cylinder section of the base body.

This invention also relates to (9) a pump dispenser wherein a trigger lock section for preventing the pull back of the trigger structure is integrated with the base body via a hinge section, and the trigger lock section is formed so as to be in contact with the final end of the outside boss section of the second valve casing section.

This invention also relates to (10) a pump dispenser wherein an inside virgin seal is provided at the final end of a cylindrical body of the piston section and a protruding shaft is provided in a cylinder receptacle section formed at the deepest end of the cylinder section.

This invention also relates to (11) a pump dispenser wherein a first valve casing section and a packing are integrated with each other to form the packing structure.

This invention also relates to (12) a pump dispenser wherein the packing structure is integrated with a tubular body.

This invention also relates to (13) a manual operative trigger-type pump dispenser mounted on a vessel wherein liquid contained in the cylinder is compressed via a piston section by the displacement of a trigger structure and is ejected through a nozzle orifice, including a base body fixed on the vessel orifice via a packing structure, a cylinder section and a vent cylinder section formed in adjacent to each other on the base body, the trigger structure including a trigger section, a second valve casing section mounted on the base body, and a trigger guide section oscillating in the vent cylinder section, a nozzle cover integrated with the second valve casing section via a hinge section and a protrusion for plugging the nozzle orifice at the top of the second valve casing section formed by the nozzle cover, the second valve casing section provided with an outside boss section and an inside boss section between which a cylinder section can oscillate, a virgin seal section for preventing the pull back of the trigger structure integrated with the vent cylinder section of the base body, a first valve casing section and a packing integrated with each other to form the packing structure, and an anti-falling section relative to the base body formed in the second valve casing section.

This invention also relates to (14) a spraying apparatus provided with the pump dispenser according to either one of (1) to (13) given above.

This invention can be constituted by combining any two or more from (1) to (13) given above provided that they are in harmony with this objective, and a spraying apparatus provided with the pump dispenser can be constituted.

The pump dispenser according to this invention can transmit precisely the motion of the trigger structure to the piston and enables the piston to operate stably.

As described above, the pump dispensers according to this invention are assured of a superb operability and smooth and precision operation, easy to use and enjoy a high reliability as products.

They transmit precisely the motion of the trigger section to the piston, and enable a stable operation of the piston.

The second valve casing of the trigger structure which includes an inside boss section and an outside boss section provides the piston section with an excellent stability of oscillation in relation to the cylinder section.

Similarly, the trigger structure which integrates the trigger section, the second valve casing and the trigger guide provides the piston with an excellent stability of oscillation.

And an anti-falling device is provided between the trigger structure and the base body to prevent any possible unexpected falling out.

The provision of a nozzle cover enables to easily plug up or open the nozzle orifice.

Because the trigger structure serves concurrently as the trigger section and the second valve casing section, and also because the first valve casing section and the packing are integrate, the whole pump dispenser consists of a limited number of components, and therefore the number of assembly work steps is reduced.

The provision of the virgin seal section, the trigger lock section and the inside virgin seal prevents the possibility of the trigger structure being drawn in and thus assures the safety of operation.

As the trigger structure is positioned in the same direction as the displacement direction of the piston section, no lag develops between them.

It is clear from the whole description of the specification that the above effect corresponds to the descriptions of specific claims.

### BRIEF DESCRIPTION OF THE DRAWING

FIG. 1 shows an example of composition of the pump dispenser in this preferred embodiment.

FIG. 2 shows the state of the pump dispenser after the virgin seal section is separated from the state of the pump dispenser shown in FIG. 1.

FIG. 3 is a sectional view of an anti-fall mechanism provided between the second valve casing section and the cylinder section.

FIG. 4 is an enlarged view showing the virgin seal section.

FIG. 5 is a sectional view of the packing structure.

FIG. 6 is a sectional view of another embodiment of the packing structure.

FIG. 7 shows the state in actual use of the pump dispenser A, and the state when the virgin seal section is removed and the trigger section is pulled.

FIG. 8 is a schematic sectional view showing an example of composition of a pump dispenser provided with the trigger lock.

FIG. 9 shows an example of composition of a pump dispenser provided with an inside virgin seal and a protruding shaft.

FIG. 10 is an enlarged view of the inside virgin seal, and (A) is a schematic sectional view and (B) is a cross sectional view as seen from the protruding shaft side.

FIG. 11 is a sectional view showing the state of the pump dispenser when the trigger structure is pulled back.

FIG. 12 is an enlarged schematic sectional view showing the inside virgin seal pushed down with a thrust of the protruding shaft and opened.

FIG. 13 is a sectional view showing a pump dispenser provided with a virgin seal section and an inside virgin seal.

FIG. 14 is a sectional view showing a pump dispenser provided with a trigger lock section and an inside virgin seal.

FIG. 15 shows a nozzle cover and a nozzle stopper for foam.

FIG. 16 shows an example of the outside boss section extending and sloping downward to be integrated with the nozzle cover.

FIG. 17 is a schematic view showing the state in use of an example of the traditional parallel displacement-type pump dispenser.

FIG. 18 is a sectional view showing the specific composition of an example of the traditional parallel displacement-type pump dispenser.

### DESCRIPTION OF THE PREFERRED EMBODIMENTS

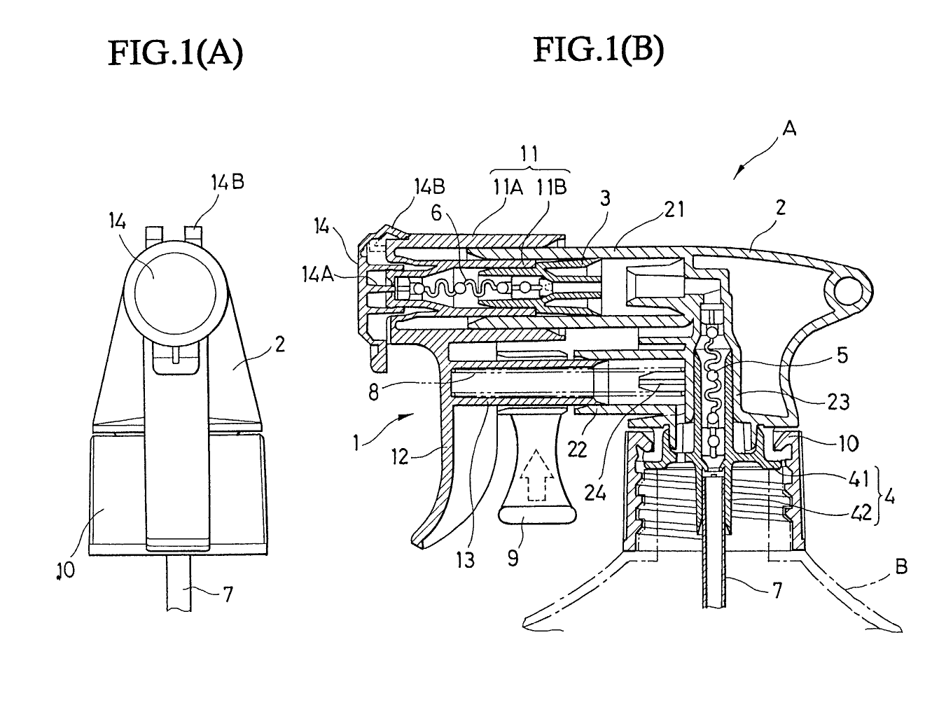

With reference to FIGS. 1-16, the preferred embodiments of pump dispenser according to this invention will be described.

To begin with, FIG. 1 shows an example of composition of the pump dispenser A according to this preferred embodiment.

This drawing, however, shows the state of the pump dispenser when the nozzle cover 14 is closed and the virgin seal 9 is not yet separated.

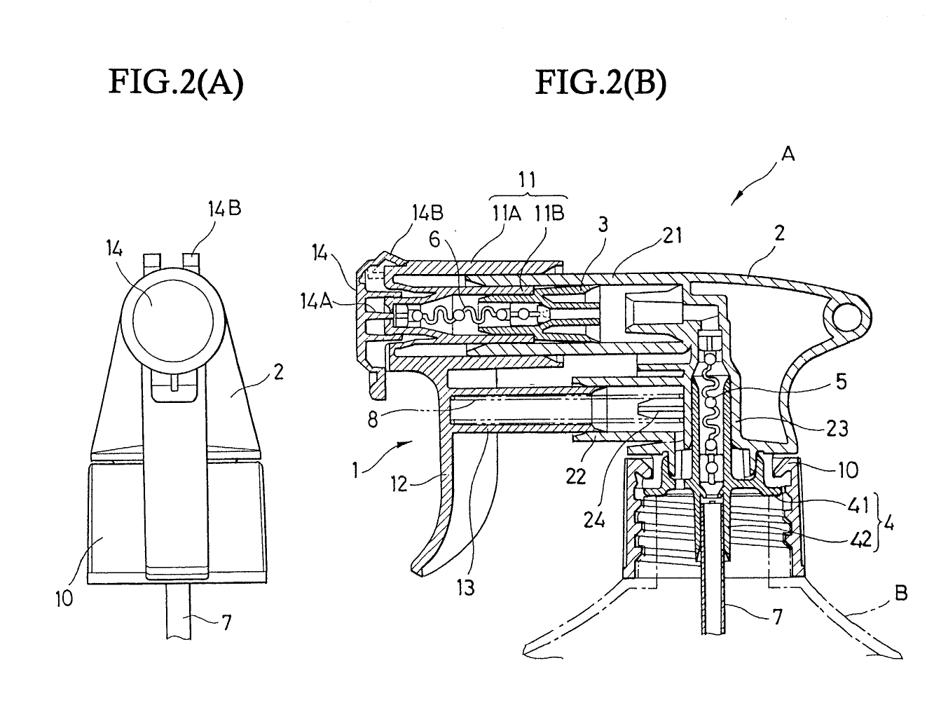

And FIG. 2 shows the state the pump dispenser after the virgin seal section 9 is separated from the state of the pump dispenser A shown in FIG. 1.

This pump dispenser A is a manual operative trigger-type pump dispenser as mounted on the vessel B in which the liquid contained in the cylinder 21 is compressed with the piston section 3 by the displacement of the trigger structure and is ejected through the nozzle orifice.

And it includes a trigger structure 1, a base body 2, a piston section 3, a packing structure 4, the first valve 5, the second valve 6, a tubular body 7, a spring body 8, a virgin seal section 9 and a cap 10.

Unlike the traditional rotary trigger, the trigger structure 1 is integrally formed by a trigger section 12 and a second valve casing section 11, and the trigger section 12 is integrated with the trigger guide section 13.

It is preferable that these three components would be integrally formed by polypropylene.

As stated below, the second valve casing section 11 is installed on the base body 2 and the trigger guide section 13 is designed to oscillate within the vent cylinder section 22 of the base body 2.

The piston section 3 is fitted at the top of the second valve casing section 11, and the piston section 3 is arranged so as to be able to oscillate in the cylinder section 2.

The second valve 6 is installed between the second valve casing section 11 and the piston section 3.

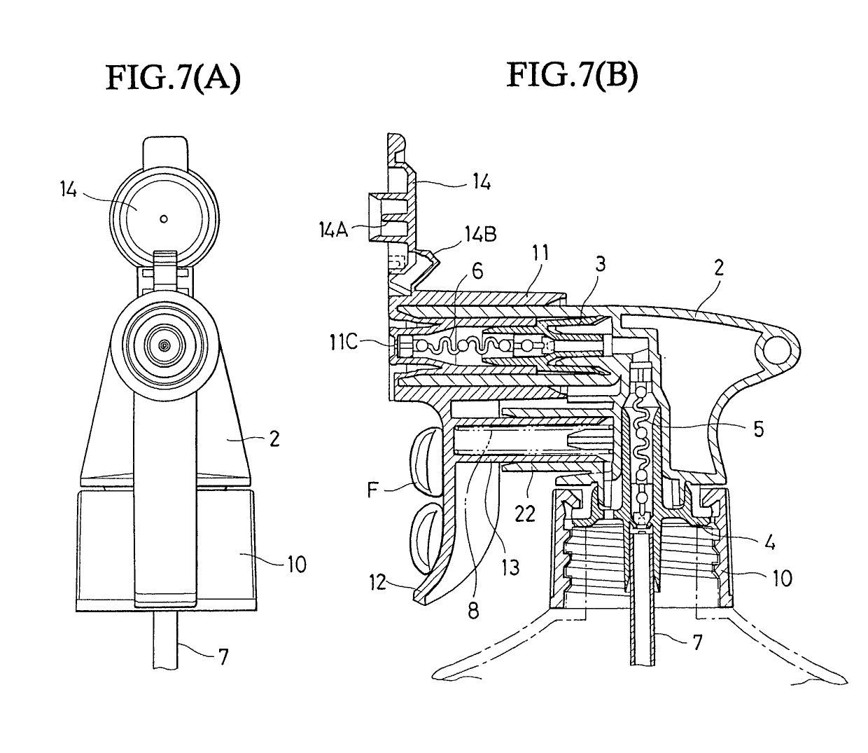

And the second valve casing section 11 has a nozzle orifice 11C (see FIG. 7 mentioned below), and it is provided with a nozzle cover 14 to plug up or open the nozzle orifice 11C.

The nozzle cover 14 is integrated with the second valve casing section 11 via a thin hinge section 14B, and a protrusion 14A is formed therein to plug up the nozzle orifice 11C.

Accordingly, the nozzle cover 14 can be swung around the thin hinge section 14B fitting with the second valve casing 11 at one end, and when it is lowered, its protrusion 14A comes into contact with the nozzle orifice 11C and plugs up the nozzle orifice 11A, and when it is raised the protrusion 14A separates from the nozzle orifice 11C and opens the nozzle orifice 11C.

The second valve casing section 11 includes an outside boss section 11A of a large diameter and an inside boss section 11B of a smaller diameter, between which the cylinder section 21 of the base body 2 is inserted with pressure, and the second valve casing section 11 is fitted into the base body 2.

In other words, as the trigger structure 1 is pulled back, the cylinder section 21 oscillates between the outside boss section 11A and the inside boss section 11B of the second valve casing section 11.

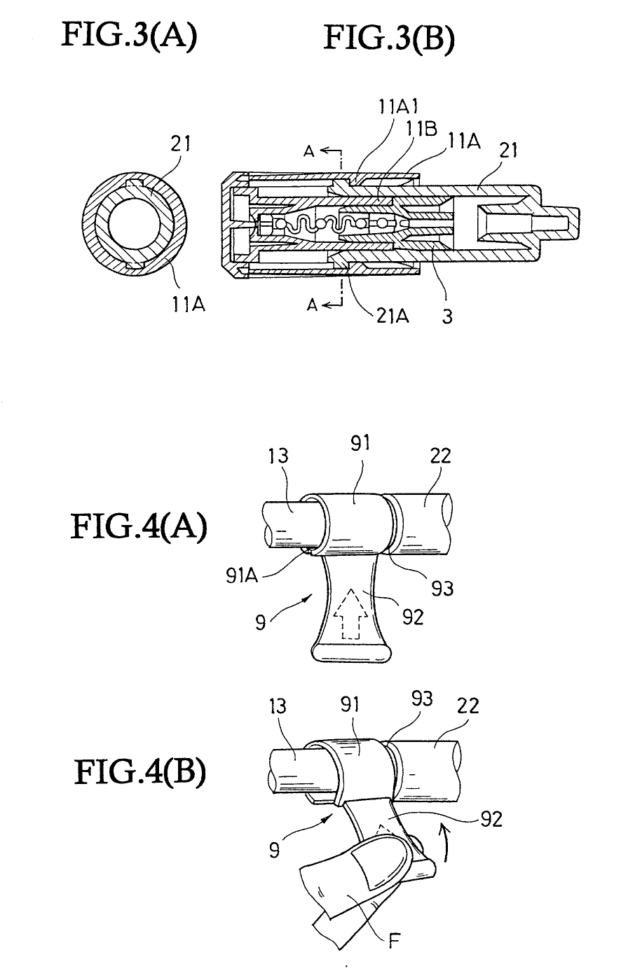

Between the second valve casing section 11 and the cylinder section 21, an anti-fall mechanism is provided as shown in the partial sectional view of FIG. 3.

In other words, in order to prevent any possible fall off of the trigger structure 1 from the base body 2, the outside boss section 11A of the second valve casing section 11 is provided with an anti-fall off mechanism from the base body 2.

The anti-fall off section is formed as a protrusion 11A1 inwards from the outside boss section 11A, and its coming into contact with the protrusion 21A on the periphery of the cylinder section 21 prevents the trigger structure from falling off.

On the other hand, the base body 2 with the trigger structure 1 mounted thereon is fixed on the mouth of the vessel B via the packing structure 4 and forms a holding piece for the trigger section 12 when it is operated with a hand.

For this reason, the base body 2 includes a cylinder section 21 for accommodating the piston section 3 and a vent cylinder section 22 running parallel thereto for inserting, guiding and letting the trigger guide 13 oscillate.

The base body 2 also includes the proximal section 23 for fixing the first valve casing section 42, and the first valve casing section 42 is inserted into this proximal section 23 and is fixed thereto.

This first valve casing section 42 includes the first valve 5 for opening and shutting the channel for the liquid flowing from the vessel into the cylinder section 21.

In other words, the first valve 5 opens and shuts the channel between the proximal section 23 of the base body 2 and the second valve casing section 11 of another body.

At the bottom of the vent cylinder 22 a cruciform protrusion 24 is provided, and this helps to position a spring 8 outside.

This spring gives return force to the trigger structure 1 when the latter reciprocates.

On the other hand, the tip of the vent cylinder section 22 the virgin seal section 9 provided with a cylindrical section 91 surrounding the trigger guide 13 is integrated via a thin metal 93.

This virgin seal section is designed to prevent the pull back of the trigger structure 1.

FIG. 4 is an enlarged view of a part of the virgin seal section 9.

The cylindrical section 91 of the virgin seal section 9 includes a notch 91A, and by pulling the handle 92, the notch 91A separates and the thin metal 93 is cut out.

Accordingly, as mentioned below, by cutting off the virgin seal 9, it becomes possible to move the trigger structure 1 in relation to the vent cylinder section 22 of the base body 2.

In other words, it becomes possible to pull the trigger section 12 of the trigger structure.

It should be noted in this connection that the handle 92 of the virgin seal section 9 is marked with a pattern showing the direction of the pull, for example an “arrow” as illustrated in the figures attached.

In the meanwhile, the first valve casing section 42 and the packing 41 are integrated to constitute the packing structure 4, and thereunder a tubular body 7 constituting the channel sucking liquid from the vessel is fixed.

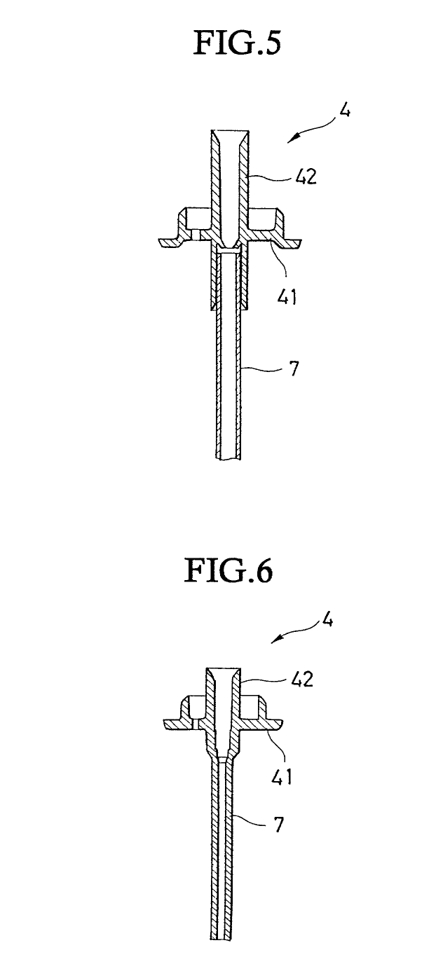

FIG. 5 is an illustration showing the packing structure.

The integration of the first valve casing section 42 and the packing 41 improves the convenience of positioning both of them.

The case wherein the first valve casing section 42, the packing 41 and the tubular body 7 are integrated is illustrated in FIG. 6.

In this case, the long tubular body 7 which is easy to hold improves the efficiency of assembly.

Thus, for the material of the packing structure 4 provided with a packing 41, the adoption of a low density polyethylene (LDPE) is preferable.

In the meanwhile, the vent cylinder section 22 is designed to guide the trigger structure 1 to be able to displace along its axis in parallel to the cylinder section 21.

The movement of the piston section 3 is very stable because the trigger guide section 13 moves simultaneously along the vent cylinder section 22.

And the piston section 3 becomes integrated with the trigger structure 1, moves in the same direction, and moreover oscillates between the outside boss section 11A and the inside boss section 11B while interpolating the cylinder section 21. Therefore, it operates in a more stable manner.

In addition, the trigger structure 1 includes a notch for venting air not illustrated and provided in a part of the trigger guide 13, and regulates the negative pressure in the vessel while the vent cylinder section 22 and the trigger guide section 13 are cut off.

The pump dispenser 4 according to this invention includes as components the trigger structure 1, the base body 2, the piston section 3, the first valve 5, the second valve 6, the packing structure 4 (the first valve casing section 42 and the packing 41 being integrated), the tubular body 7 totaling seven components altogether. When the tubular body 7 is integrated with the packing structure 4, however, the number of components will be six in total.

As the number of components are fewer than those of the traditional manual operative trigger-type pump dispenser (traditionally, the piston, the trigger and the second valve casing are separate, and the first valve casing and the packing are separate), the number of assembly steps will be fewer and the production efficiency will improve.

In the meanwhile, as the material of the trigger structure 1, the base body 2, and the cap 10, it is preferable to use polypropylene (PP), and as the material of the valves 5 and 6, the piston section 3 and the packing structure 4, it is preferable to use low density polyethylene (LDPE).

FIG. 7 shows the state in use of the pump dispenser A described above when the trigger section is pulled in after removing the virgin seal section.

To operate the trigger section 12, as shown in the figure, in the first place two fingers F (for example, index finger and middle finger) should be used to hold the trigger section 12 or the bifurcation between the index finger and the thumb (here referred to as “the root of the thumb” for the sake of convenience) should be applied to the area behind the base body 2 reserved for the root of the thumb.

To begin with, a new unused pump dispenser A should be made ready for use.

At first, the virgin seal section 9 should be cut off from the vent cylinder section 22 of the base body 2 by holding the handle 92 of the virgin seal section 9 (see FIG. 4).

Then, the nozzle cover 14 should be swung upward to liberate the nozzle orifice 11C from the plugged state to the open state.

At this point, when short operations of pulling slightly the trigger section 12 of the trigger structure 1 are repeated many times, the liquid contained in the vessel is discharged into the cylinder section 21, and the pump dispenser will be ready for regular use.

Then, the trigger structure 1 should be pulled strongly against the elastic force of the spring 8 while holding the pump dispenser A.

Then, the first valve 5 closes and the second valve 6 opens leading to the ejection of the liquid contained in the cylinder section 21 from the nozzle orifice 11C.

Thereafter, when the trigger structure 1 is liberated, due to the reactionary force of the spring 8, the trigger structure begins to return, and as a result the piston section 3 also start returning to its original position.

And then, the first valve 5 opens and the second valve 6 closes creating a negative pressure in the cylinder section 21 and causing the liquid contained in the vessel to be sucked.

In the operation described above, by pulling two fingers, the pushing pressure for displacing the trigger structure 1 is dispersed between the trigger guide section 13 and the vent cylinder section 22 as well as between the piston section 3 and the cylinder section 21.

As described above, the action of the spring 8 is supported by the trigger guide section 13 along the vent cylinder section 22 and therefore the motion of the spring 8 becomes very stable.

Moreover, since the trigger structure 1 reciprocates while the cylinder section 21 of the base body 2 is interpolated between the outside boss 11A and the inside boss 11B of the trigger structure 1, a very stable linear displacement motion can be assured.

In addition, due to the provision of an anti-fall off mechanism as mentioned above between the trigger structure 1 and the base body 2, in other words between the cylinder section 21 and the second valve casing section 11, the two components do not separate each other inadvertently.

On the other hand, as the nozzle orifice 11C can be simply plugged by drawing down the nozzle cover 14, safety is assured.

In the above preferred embodiment, the case wherein the virgin seal section is integrated with the top of the vent cylinder section via a thin metal while enclosing the trigger guide section is described (see FIG. 1).

The reason behind such arrangement is to prevent the pull back of the trigger structure in an unused new pump dispenser A.

Therefore, the virgin seal section needs not to be at the top of the vent cylinder section and can take another form provided that a similar operational effect can be obtained.

And the virgin seal section is designed for only one-time use. However, instead of cutting off the virgin seal, it is possible to adopt a mechanism of locking the trigger as described below so that it may be used repeatedly.

On the other hand, the measures taken to prevent the pull back of the trigger structure are taken in order to prevent any inadvertent leakage of liquid before the spraying apparatus is used. Therefore, by blocking the passage of liquid in the pump dispenser, the leakage of liquid can be prevented with an even greater certainty.

Therefore, with reference to drawings, the trigger lock section and the virgin seal in the pump dispenser (inside virgin seal) will be described by referring to their respective examples.

[Preferred Embodiment of the Trigger Lock Section]

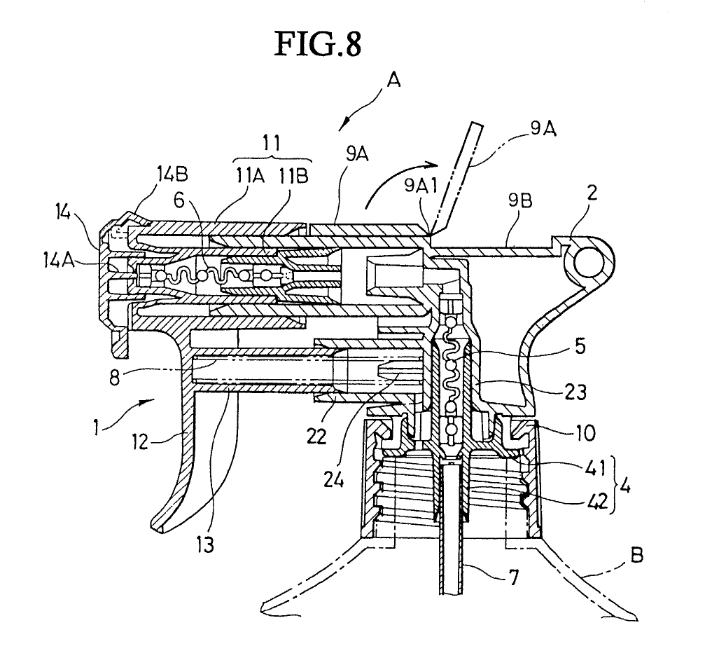

FIG. 8 is a schematic sectional view showing an example of composition of a pump dispenser provided with a trigger lock section for locking the trigger.

The trigger lock section 9A is integrated with the base body 2 via the hinge section 9A1 and is formed so that it can be swung upwards.

And before the spraying apparatus is put to use, as shown by a solid line, it is formed so that it may touch the rear end of the outside boss section 11A of the second valve casing section 11.

By making such an arrangement, any attempt to pull back the trigger structure before the spraying apparatus is put to use will be blocked by this trigger lock section 9A, and any inadvertent pull back of the trigger structure 1 can be prevented.

And at the beginning of use, as shown in a chain line with two dots, by swinging upward the trigger lock section 9A, the trigger structure 1 will be free of obstacles and can be pulled back freely.

And as shown in the figure once a cavity 9B of a form befitting the trigger lock section 9A that has swung down on the base body 2 is created, the trigger lock section 9A can be accommodated therein, and the trigger lock section 9A will not come in the way when the spraying apparatus is in use.

Incidentally, in this preferred embodiment, any components other than said trigger lock section 9A may be designed in the same way as the preferred embodiment previously mentioned.

[Inside Virgin Seal]

And now the inside virgin seal will be described.

The inside virgin seal is designed to block the channel of liquid in the pump dispenser as described above. Specifically, when the trigger structure provided with a seal so as to block the channel of liquid is pulled back, the protruding shaft opens the inside virgin seal.

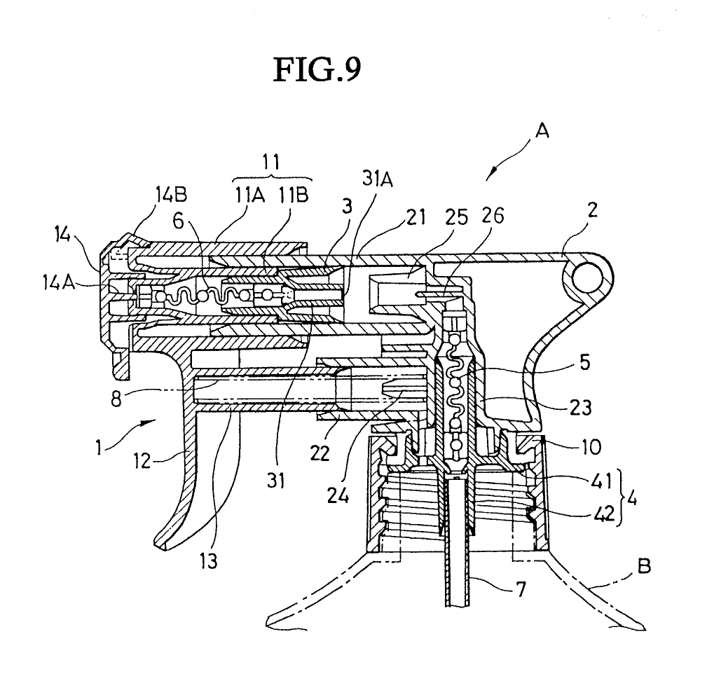

FIG. 9 shows an example of composition of a pump dispenser provided with an inside virgin seal and a protruding shaft.

The inside virgin seal 31A is formed at the final end of the cylindrical body 31 of the piston section 3, and blocks the opening mouth of the latter before the spraying apparatus is put to use.

And in the cylinder receptacle section 25 provided at the deepest end of the cylinder section 21, a protruding shaft 26 is provided.

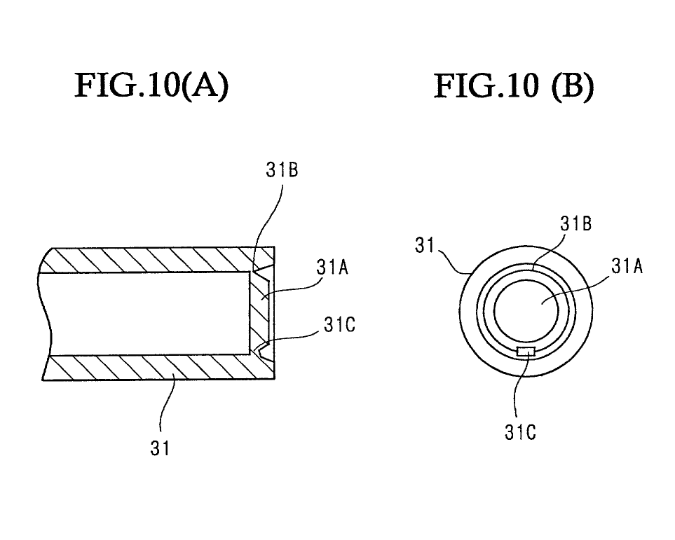

FIG. 10 is an enlarged view of the inside virgin seal of this state, and (A) is a schematic sectional view and (B) is a cross sectional view taken from the side of the protruding shaft.

The inside virgin seal 31A is connected with the final end of the cylindrical body 31 via a thin metal 31B surrounding its periphery.

Since this thin metal 31B is weak in terms of physical strength, a thrust of the protruding shaft 26 described below suffices to cut off easily this part.

And since a part of the thin metal section 31B is made thick (hinge section 31C) and this hinge section 31C is strong in terms of physical strength, it is not cut off and can keep the inside virgin seal 31A linked with the cylindrical body 31.

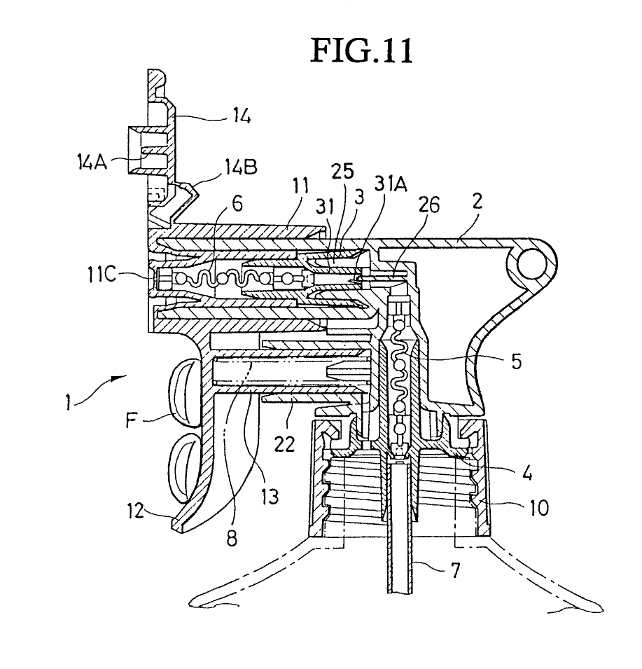

FIG. 11 is a sectional view showing the state of the pump dispenser when the spraying apparatus has been put to use and the trigger structure is pulled back.

When the trigger structure 1 is pulled back, the cylindrical body 31 of the piston section 3 is inserted into the cylinder receptacle 25, and in this state a thrust of the protruding shaft 26 causes the inside virgin seal 31A to fall down and opens the mouth.

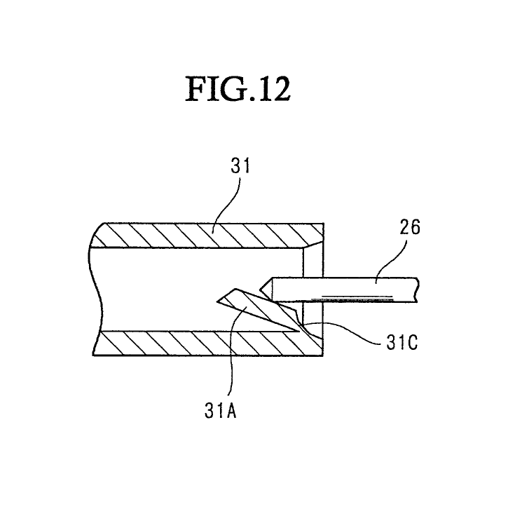

FIG. 12 is a schematic sectional view showing the inside virgin seal opened by a thrust of the protruding shaft.

The inside virgin seal 31A is placed under pressure from the thrust of the protruding shaft 26 leading to the cutting off of the thin metal part 31B.

However, the hinge section 31C is not broken, and the inside virgin seal 31A swings down around this hinge section 31C and is opened.

If the top end of the protruding shaft 26 is made conical or spherical as shown in the figure, it will facilitate the top end to catch the inside virgin seal, and therefore such an arrangement will be preferable.

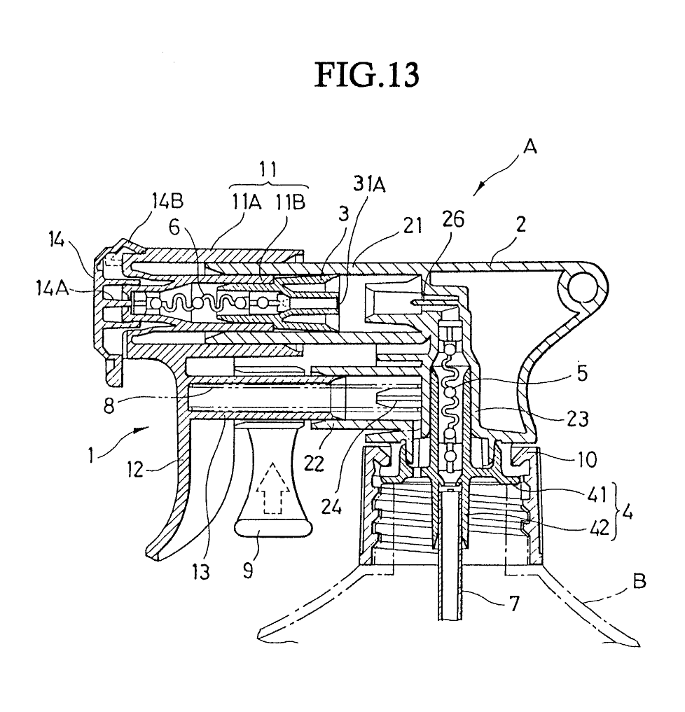

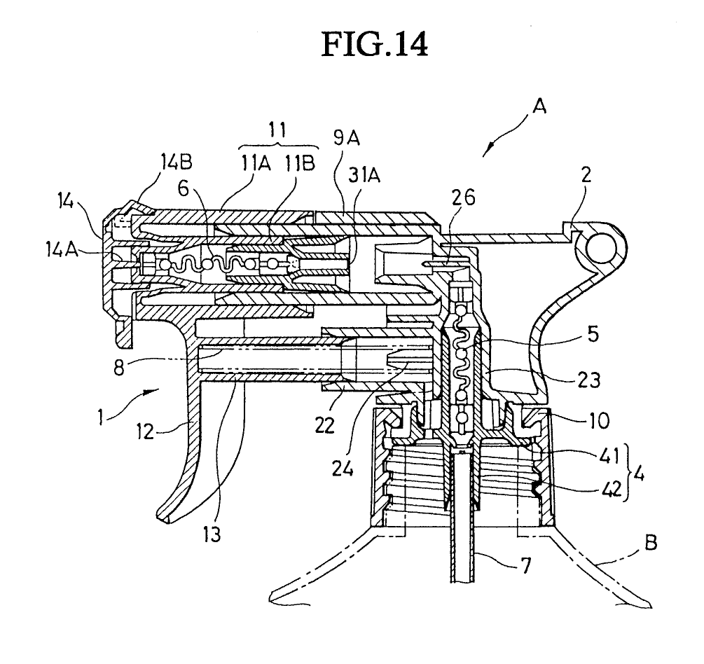

Now for the reference of the reader, a pump dispenser provided with the virgin seal section 9 and the inside virgin seal shown in the first preferred embodiment will be illustrated in FIG. 13, and a pump dispenser provided with the trigger lock section 9A and the inside virgin seal wil be illustrated in FIG. 14.

We have thus far described this invention, but this invention is not limited to said preferred embodiments, and various variations are possible within the limits of this invention.

For example, the form of virgin seal section is not limited to circular one, and variations can be made according to the needs.

Also the types of vessels to which the pump dispenser A may be mounted are free.

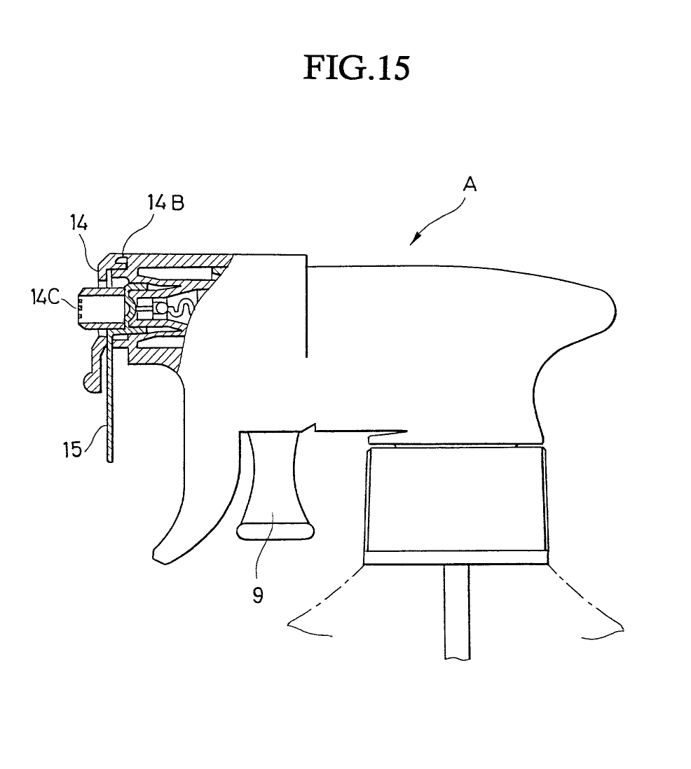

As shown in FIG. 15, by adopting a nozzle cover 14 for foaming for the nozzle cover 14, it is possible to eject liquid in the form of foam.

To be more specific, by adopting a nozzle cover 14 provided with a mesh section 14C for foaming and by letting the liquid ejected from the nozzle orifice pass through the mesh section 14C, the ejection will be foamy.

In this case, it is preferable to provide a nozzle stopper 15 between the nozzle cover 14 and the nozzle orifice for closing the nozzle.

Therefore, when the pump dispenser is put to use, in the first place the nozzle cover 14 is opened, the nozzle stopper 15 is removed, and then the nozzle cover 14 is closed for use.

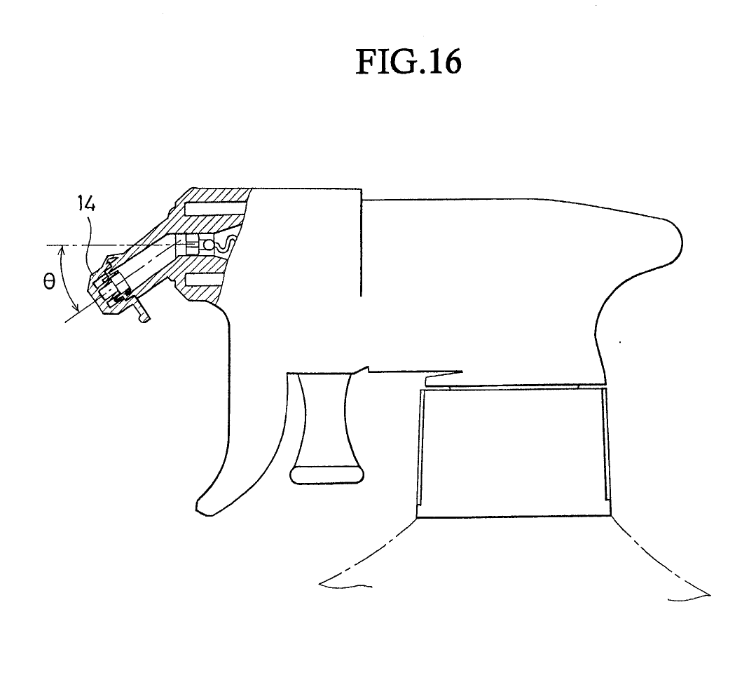

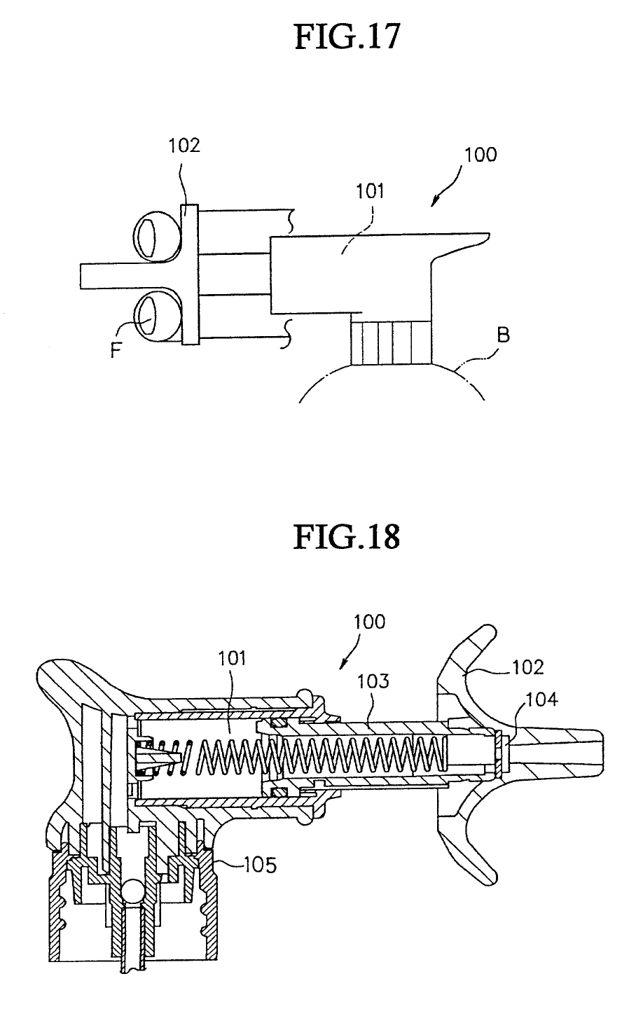

And as shown in FIG. 16, the downward sloping extension of the outside boss section 11A of the second valve casing 11 can be integrated with the nozzle cover 14.

Incidentally, in this case, the extension section can be made into a nozzle adapter separate from the second valve casing section 11.

By giving a downward inclination degree of θ, for ejecting the liquid downward there will be no need to incline downward the whole pump dispenser including the vessel (in other words, the whole spraying apparatus).

Since this arrangement enables to avoid the development of momentum due to the weight of the vessel filled with liquid, no material burden is applied on the hands and the pump dispenser made according to this arrangement will be easy to use.

What is claimed is:

1. A manual operative pump dispenser mounted on a vessel wherein liquid contained in a cylinder section is compressed with a piston section by the displacement of a trigger structure and is ejected through a nozzle orifice, comprising:
a base body fixed on a vessel orifice via a packing structure;
a cylinder section and a vent cylinder section formed in adjacent to each other on the base body; and
the trigger structure including a trigger section, a second valve casing section mounted on the base body, and a trigger guide section oscillating in the vent cylinder section.

2. The pump dispenser according to claim 1 wherein a nozzle cover is integrated with the second valve casing section via a hinge section.

3. The pump dispenser according to claim 2 wherein the nozzle cover includes a protrusion designed to block the nozzle orifice.

4. The pump dispenser according to claim 2 wherein the nozzle cover includes a mesh section for foaming and a nozzle stopper is provided between the nozzle cover and the nozzle orifice for closing the nozzle orifice.

5. The pump dispenser according to claim 1 wherein the second valve casing section includes an anti-falling section relative to the base body.

6. The pump dispenser according to claim 1 wherein the second valve casing section includes an inside boss section and an outside boss section between which the cylinder section oscillates.

7. The pump dispenser according to claim 1 wherein a downward inclining extension of the outside boss section of the second valve casing section forming a nozzle cover is integrated thereto.

8. The pump dispenser according to claim 1 wherein a virgin seal section for preventing the pull back of the trigger structure is integrated with the vent cylinder section of the base body.

9. The pump dispenser according to claim 1 wherein a trigger lock section for preventing the pull back of the trigger structure is integrated with the base body 2 via a hinge section, and the trigger lock section is formed so as to be in contact with the final end of the outside boss section of the second valve casing section.

10. The pump dispenser according to claim 1 wherein an inside virgin seal is provided at the final end of a cylindrical body of the piston section and a protruding shaft is provided in a cylinder receptacle section formed at the deepest end of the cylinder section 21.

11. The pump dispenser according to claim 1 wherein a first valve casing section and a packing are integrated with each other to form the packing structure.

12. The pump dispenser according to claim 11 wherein the packing structure is integrated with a tubular body.

13. A manual operative trigger-type pump dispenser mounted on a vessel wherein liquid contained in a cylinder section is compressed via a piston section by the displacement of a trigger structure and is ejected through a nozzle orifice, comprising:
a base body fixed on a vessel orifice via a packing structure;
a cylinder section and a vent cylinder section formed in adjacent to each other on the base body;
the trigger structure including a trigger section, a second valve casing section mounted on the base body, and a trigger guide section oscillating in the vent cylinder section;
a nozzle cover integrated with the second valve casing section via a hinge section and a protrusion for plugging the nozzle orifice at the top of the second valve casing section formed by the nozzle cover;
the second valve casing section provided with an outside boss section and an inside boss section between which a cylinder section can oscillate;
a virgin seal section for preventing the pull back of the trigger structure integrated with the vent cylinder section of the base body;
a first valve casing section and a packing integrated with each other to form the packing structure; and
an anti-falling section relative to the base body formed in the second valve casing section.

14. A spraying apparatus provided with the pump dispenser according to either one of the claims 1 to 13.
